(19) United States
(12) Patent Application Publication
(10) Pub. No.: US 2009/0023023 A1
(43) Pub. Date: Jan. 22, 2009

(54) Fuel Cell Control System

(75) Inventor: Hiromichi Miwa, Kanagawa-ken (JP)

Correspondence Address: FOLEY AND LARDNER LLP;SUITE 500, 3000 K STREET NW, WASHINGTON, DC, 20007, US

(73) Assignee: NISSAN MOTOR CO., LTD.

(21) Appl. No.: 11/918,229

(22) PCT Filed: Apr. 24, 2006
(86) PCT No.: PCT/JP2006/308538

§ 371 Date: Oct. 11, 2007

(30) Foreign Application Priority Data
Jun. 15, 2005 (JP) 2005-174855

(51) Int. Cl. H01M 8/04

(52) U.S. Cl. 429/24; 429/22; 429/25

(57) ABSTRACT

A fuel cell control system of the present invention includes a fuel cell (10) using as the electrolyte (11) an ionic conductor containing a cation component, an anion component, and a polar substance; and a polar substance amount controller controlling an amount of the polar substance in the electrolyte (11) according to the operating condition of the fuel cell. The fuel cell control system can maintain high protonic conductance in all the ranges from the low-load operation range to the high-load operation range.

### TECHNICAL FIELD

The present invention relates to a fuel cell control system and, more specifically, relates to a fuel cell control system including a polar substance amount controller which controls an amount of polar substance in an electrolyte according to an operating condition of a fuel cell. Herein, the fuel cell uses an ionic conductor containing cation and anion components as the electrolyte.

### BACKGROUND ART

In a conventional fuel cell, a sulfonic acid type electrolyte was used. The sulfonic acid type electrolyte was characterized by having a high protonic conductivity with water added, but the maximum operating temperature thereof was about 80° C.

In recent years, it has been proposed to apply room-temperature molten salt to the fuel cell. The room-temperature molten salt can be used in a high temperature range up to about 200° C. and provides high protonic conductivity at 100° C. or more. Specifically, a fuel cell is proposed which uses a protonic conductor containing room-temperature molten salt and assumes a non-humidification operation (see Japanese Patent Unexamined Publication No. 2003-123791). Another fuel cell is proposed which uses room-temperature molten salt composed of a hydrophobic anion and a hydrophobic cation to prevent incorporation of water into the room-temperature molten salt (see Japanese Patent Translation Publication No. 2003-535450).

### DISCLOSURE OF INVENTION

However, the fuel cells with room-temperature molten salt applied thereto have a problem that the protonic conductivity is lowered in a low-temperature range to a value below that of the conventional sulfonic acid type electrolyte containing water. In addition, it is assumed that the aforementioned fuel cell with the room-temperature molten salt applied thereto is used without water. Furthermore, the above publication reported that performances of the fuel cell were degraded by incorporation of water.

On the other hand, in our experiments, new technical knowledge was obtained in which adding a polar substance such as water to hydrophilic room-temperature molten salt increases the protonic conductance and improves fuel cell performances (for example, I-V characteristics).

The present invention was made based on the problems involved in the conventional arts and the aforementioned technical knowledge, and an object of the present invention is to provide a fuel cell control system which can maintain high protonic conductivity in all ranges from a low-load operation range (low-temperature range) to a high-load operation range (high-temperature range).

A fuel cell control system according to a first aspect of the present invention includes: a fuel cell using as an electrolyte an ionic conductor containing a cation component, an anion component, and a polar substance; and a polar substance amount controller controlling an amount of the polar substance in the electrolyte according to an operating condition of the fuel cell.

A fuel cell control system according to a second aspect of the present invention includes: a fuel cell using as an electrolyte an ionic conductor containing a cation component, an anion component, and a polar substance; and polar substance amount control means for controlling an amount of the polar substance in the electrolyte according to an operating condition of the fuel cell.

### BRIEF DESCRIPTION OF THE DRAWINGS

FIG. 1 is a graph showing an I-V characteristic when a water content of an electrolyte increases.

FIG. 2 is a graph showing a relation between inverse of temperature and protonic conductivity.

FIG. 3 is a graph showing an I-V characteristic.

FIG. 4 is a flowchart showing control by the fuel cell control system according to the present invention.

FIG. 5 is a configuration diagram showing a first embodiment of the fuel cell control system according to the present invention.

FIG. 6 is a flowchart showing control by the first embodiment of the fuel cell control system according to the present invention.

FIG. 7 is a configuration diagram showing a second embodiment of the fuel cell control system according to present invention.

FIG. 8 is a flowchart showing control by the second embodiment of the fuel cell control system according to the present invention.

FIG. 9 is a configuration diagram showing a third embodiment of the fuel cell control system according to present invention.

FIG. 10 is a flowchart showing control by the third embodiment of the fuel cell control system according to the present invention.

FIG. 11 is a graph showing relations between load and each of pump flow rate and fan motor rotation speed in cases of a normal control and an increasing control.

FIG. 12 is an explanatory view showing a configuration of a generator modeled after the fuel cell.

FIG. 13 is a graph showing power generation performances of Example 1 and Comparative Example 1.

### BEST MODE FOR CARRYING OUT THE INVENTION

A description is given of a fuel cell control system of the present invention in detail below.

A fuel cell control system of the present invention controls an amount of a polar substance in an electrolyte of a fuel cell which uses as the electrolyte an ionic conductor including a cation component, an anion component, and the polar substance. Specifically, the fuel cell control system of the present invention includes a polar substance amount controller which controls the amount of polar substance in the electrolyte according to an operating condition of the fuel cell. By including the polar substance amount controller which controls the amount of polar substance in the electrolyte according to the operating condition, the fuel cell control system can maintain high protonic conductivity in all ranges from a low-load operation range (a low-temperature range) to a high-load operation range (a high-temperature range).

First, the ionic conductor used in the fuel cell of the present invention is described in detail.

The ionic conductor used in the electrolyte of the present invention contains a polar substance, a cation component, and an anion component. Such a configuration can increase the protonic conductance.

In the present invention, it is desirable that all or a part of the cation component be composed of a molecular cation and all or a part of the anion component be composed of a molecular anion. Such a configuration allows the cation and anion components to form a complex ion or the like in conjunction with the polar substance, thus further increasing the protonic conductivity. It is more desirable that the entire cation component be composed of a molecular cation and the entire anion component be composed of a molecular anion from the perspective of easy formation of the complex ion with a polar substance. The “molecular cation” and “molecular anion” mean a polyatomic cation and a polyatomic anion, respectively.

Furthermore, in the present invention, it is desirable that the ionic conductor include a molecular cation and a molecular anion which constitute a room-temperature molten salt (ionic liquid). By containing such a room-temperature molten salt in the electrolyte, it is possible to prevent voltage reduction due to diffusion overvoltage (flooding) by produced water, which was caused in a conventional fuel cell requiring addition of water, and allows for power generation with high current density. The fuel cell itself can be therefore miniaturized. Furthermore, since the high temperature operation can be carried out, a heat radiation system also can be miniaturized. On the other hand, both of the cation and anion components constituting such room-temperature molten salt are not necessarily composed of a molecular cation and a molecular anion, respectively. Herein, the “room-temperature molten salt” is a salt molten at room temperature and indicates a stable medium which does not evaporate at high temperature and has high polarity and specific heat. As such a room-temperature molten salt, a typical one is a Brönsted acid-base type salt. Details thereof are described later.

In the present invention, it is desirable that the molecular cation include at least one type of a heteroatom in a molecule. Such a molecular cation containing a heteroatom has high ionic conductance and further increases the protonic conductivity. The heteroatom is an atom other than a carbon atom (C) and a hydrogen atom (H), and typical examples thereof are an oxygen atom (O), a nitrogen atom (N), a sulfur atom (S), a phosphorus atom (P), a fluorine atom (F), a chlorine atom (Cl), a bromine atom (Br), an iodine atom (I), a boron atom (B), a cobalt atom (Co), an antimony atom (Sb).

Furthermore, in the present invention, it is desirable that all or a part of the room-temperature molten salt be a hydrophilic room-temperature molten salt. Containing water as the later-described polar substance, such a room-temperature molten salt can enhance a water retention capacity of the ionic conductor, thus having a more effect on increasing the protonic conductance.

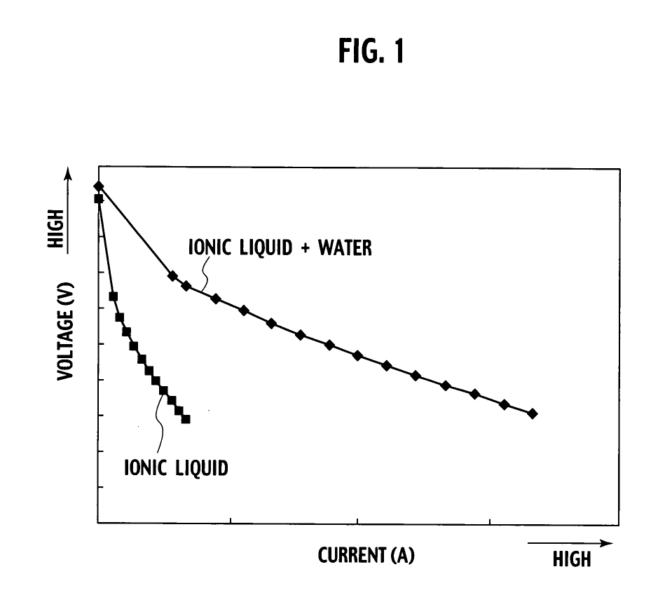

Next, a concrete description is given of control by the fuel cell control system of the present invention using the drawings. FIG. 1 shows an I-V characteristic when the water content of the electrolyte is increased by the polar substance amount controller. As shown in the figure, it is found that by adding water as the polar substance to the room-temperature molten salt, the inclination corresponding to the IR loss is reduced.

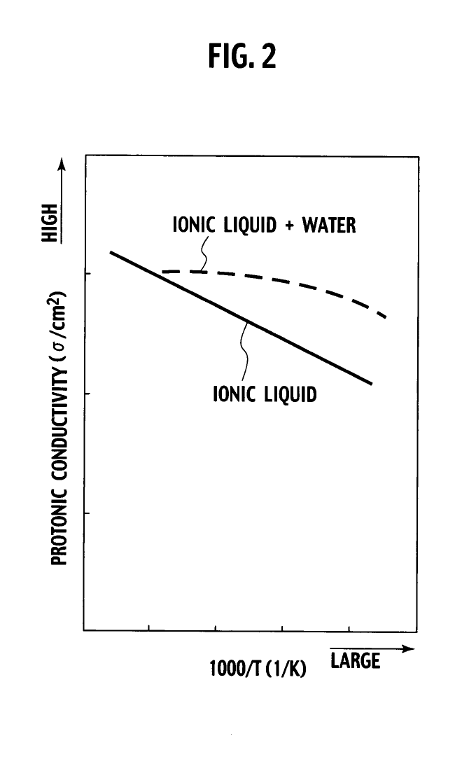

FIG. 2 shows relations between inverse of temperature and protonic conductivity in a case of only the room-temperature molten salt and a case of the room-temperature molten salt with water added. As shown in the figure, it is found that, by adding water to the room-temperature molten salt, the protonic conductivity of the electrolyte is increased in most temperature ranges.

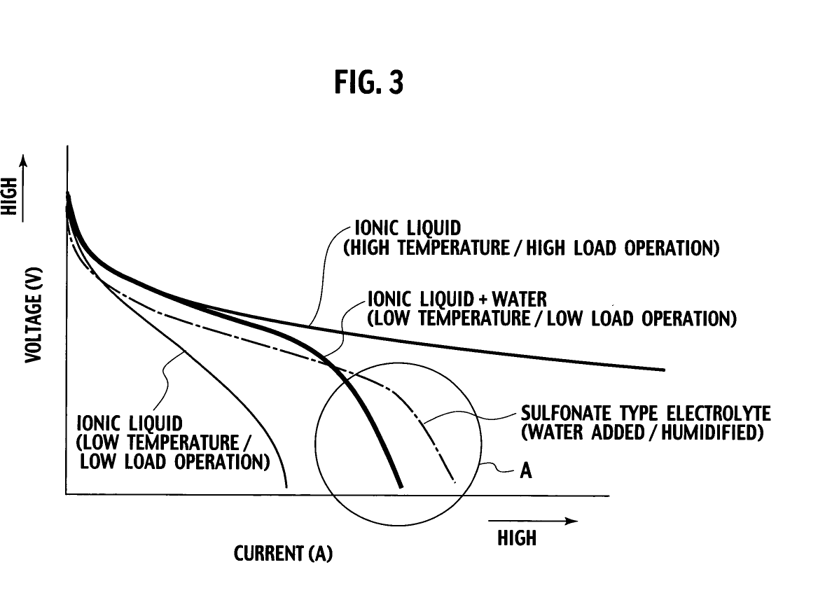

FIG. 3 shows the I-V characteristic in each condition. As shown in the figure, in a condition that the fuel cell is operated at low temperature/low load (low current density), it is desirable to take control so that the water content is maintained or increased in order to increase the protonic conductivity for an improvement in the performance of the fuel cell. In other words, the I-V characteristic in the case of the room-temperature molten salt mixed with water is better than that in the case of only the room-temperature molten salt.

On the other hand, in a condition that the fuel cell is operated at high temperature/high load (high current density), an amount of heat generated from the fuel cell increases, and the protonic conductivity of the room-temperature molten salt which does not contain water is increased (see FIG. 2). Accordingly, it is desirable to take control for an improvement in the performance of the fuel cell so that the water content of the electrolyte is reduced and water produced during power generation of the fuel cell is prevented from condensing within the fuel cell. In other words, the I-V characteristic in the case of only the room-temperature molten salt is better than that in the case of the room-temperature molten salt mixed with water.

As shown in reference mark A in FIG. 3, the I-V characteristic tends to be degraded at working temperature of the conventional fuel cell using sulfonic acid electrolyte when the room-temperature molten salt is mixed with water. This is thought at this time to be because the voltage is lowered by flooding due to the produced water.

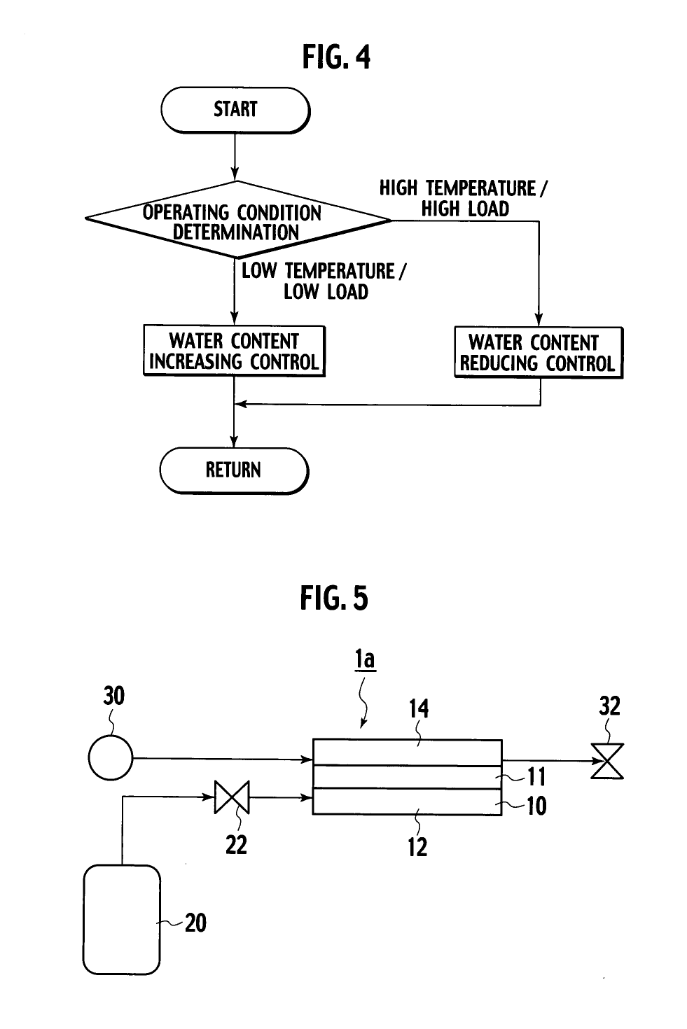

FIG. 4 shows a control flow of the fuel cell control system of the present invention. As shown in the figure, first, the operating condition of the fuel cell is determined. In the case of low temperature/low load (low current density), control to increase the water content is carried out by the polar substance amount controller, and in the case of high temperature/high load (high current density), control to reduce the water content is carried out. The protonic conductivity can be therefore increased in the case of low temperature/low load (low current density), and the fuel cell is allowed to operate without flooding to high temperature/high load (high current density).

### FIRST EMBODIMENT

In the present invention, the polar substance amount controller is desirably an operating pressure controller which controls pressure of gas within the fuel cell. As the operating pressure controller, for example, it is possible to apply a throttle valve installed in a gas exhaust passage of a cathode of the fuel cell. FIG. 5 shows a configuration of a fuel cell control system of a first embodiment of the present invention. As shown in the figure, the fuel cell control system 1a of the present invention includes a hydrogen tank 20, a fuel cell 10, and a throttle valve 32 as an example of the operating pressure controller. The fuel cell 10 includes: an electrolyte 11 including the aforementioned ionic conductor; an anode 12 provided on a surface of the electrolyte 11; and a cathode 14 provided on the other surface thereof. To the anode 12 of the fuel cell 10, hydrogen is supplied from the hydrogen tank 20 through a hydrogen regulator 22. On the other hand, to the cathode 14 of the fuel cell 10, oxidation gas (air) is supplied through a compressor 30. The operating pressure is controlled by the throttle valve 32 according to the operating condition. Herein, the operating pressure is gas pressure at least one of the anode 12 and cathode 14.

In the low temperature/low load (low current density) operating condition, an opening of the throttle valve 32 is reduced in order to increase the operating pressure. Increasing the operating pressure suppresses release of water within the electrolyte and allows water produced in power generation to easily condense within the fuel cell. The water content of the electrolyte can be therefore maintained or increased. Accordingly, the protonic conductivity of the electrolyte 11 is increased even in the low temperature/low load state, and the performance of the fuel cell can be increased.

On the other hand, in the operating condition of high temperature/high load (high current density), the amount of heat generated by the fuel cell increases, and the room-temperature molten salt which does not contain water has high protonic conductivity. In this operating condition, the opening of the throttle valve 32 is increased in order to reduce the operating pressure. Reducing the operating pressure promotes release of water within the electrolyte and makes it difficult for water produced in power generation to condense. The water content of the electrolyte can be therefore reduced. Accordingly, the protonic conductivity of the electrolyte 11 is increased even in the high temperature/high load state, and the performance of the fuel cell is increased. Moreover, it is possible to reduce load on a compressor which supplies the oxidation gas (air) under pressure to the fuel cell in the high load operation, thus reducing the size and cost of the compressor.

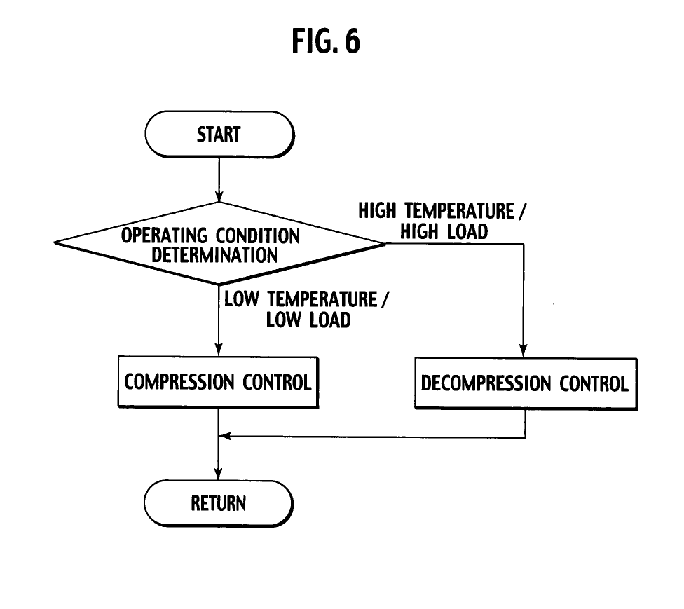

FIG. 6 shows a control flow of the fuel cell control system of the first embodiment. As shown in the figure, first, the operating condition of the fuel cell is determined, and in the case of low temperature/low load, control to increase pressure is carried out by the operating pressure controller. In the case of high temperature/high load, control to reduce pressure is carried out. This increases the protonic conductivity at low temperature/low load. Furthermore, the fuel cell can operate without flooding at high temperature/high load. The fuel cell itself can be therefore miniaturized.

In the present invention, preferably, the water content of the electrolyte is 0.01 to 50%. As the water content increases, the protonic conductivity increases. However, considering the operation at high temperature/high load, the water content is desirably not more than 50%. More preferably, the water content of the electrolyte is 0.01 to 25%. As described above, the protonic conductivity increases as the water content increases. When the water content exceeds 25%, the characteristics (viscosity and surface tension) of the room-temperature molten salt tend to change, and the contact state of the room-temperature molten salt with an electrode catalytic layer of the fuel cell may change to cause an increase in flooding. Still more preferably, the water content of the electrolyte is 0.01 to 10%. This is because even the water content of about 10% can provide high protonic conductivity.

### SECOND EMBODIMENT

In the present invention, the polar substance amount controller is desirably a humidity controller which controls humidity of at least oxidation gas among gases supplied to the fuel cell. In the present invention, moreover, the humidity controller is desirably a humidifier installed in a gas supply passage of an air electrode of the fuel cell. The humidities of both oxidation gas and hydrogen may be controlled.

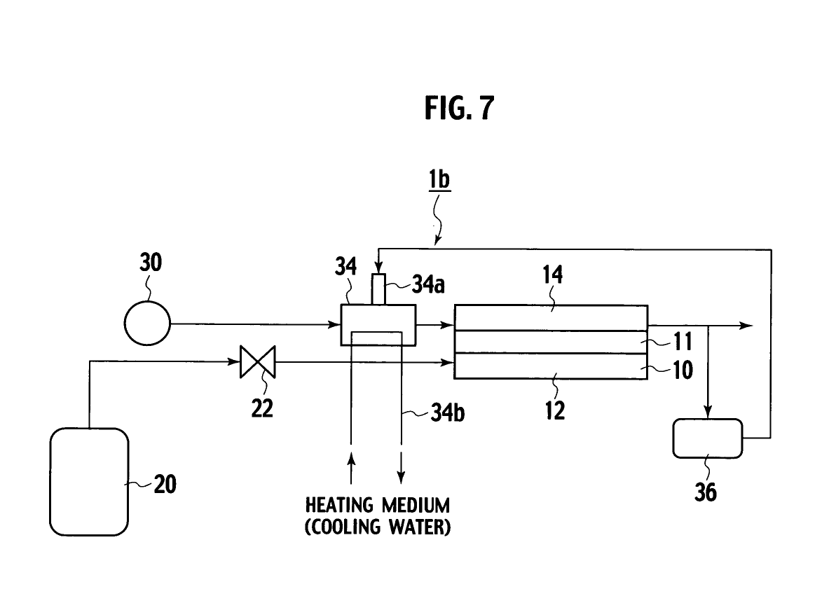

FIG. 7 shows a configuration of a fuel cell control system of a second embodiment of the present invention. As shown in the figure, the fuel cell control system 1b of the present invention includes: a hydrogen tank 20; a fuel cell 10 including an electrolyte 11, an anode 12, and a cathode 13; and a humidifier 34 as an example of the humidity controller and further includes a water collection tank 36.

To the anode 12 side of the fuel cell 10, hydrogen is supplied from the hydrogen tank 20 through a hydrogen regulator 22. On the other hand, to the cathode 14 side of the fuel cell 10, oxidation gas (air) is supplied through a compressor 30 and the humidifier 34. The humidity of the oxidation gas is controlled by the humidifier 34 according to the operating condition. In the humidifier 34, a heating medium such as cooling water flows in a flow passage 34. Moreover, a part of water discharged from the cathode 14 is stored in the water collection tank 36 and supplied to the humidifier 34 through a water supply control valve 34a attached to the humidifier 34. In this example, the humidity controller is shown only on the cathode 14 side. However, the humidity controller may be attached to the anode 13 side or each side.

In the low temperature/low load (low current density) operating condition, the humidifier 34 is activated to increase the humidity of the oxidation gas. Increasing the humidity of the oxidation gas suppresses release of water within the electrolyte and promotes introduction of water produced in power generation into the electrolyte. The water content of the electrolyte can be therefore maintained or increased. Accordingly, the protonic conductivity of the electrolyte 11 is increased even at low temperature/low load, and the performance of the fuel cell can be increased.

On the other hand, in the high temperature/high load (high current density) operating condition, the amount of heat generated by the fuel cell increases, and the room-temperature molten salt which does not contain water also has high protonic conductivity. In this operating condition, the humidifier is stopped to reduce the humidity of the oxidation gas. Reducing the humidity of the oxidation gas promotes release of water within the electrolyte and makes it difficult for water produced during power generation to condense. The water content of the electrolyte can be therefore reduced. Accordingly, the protonic conductivity of the electrolyte 11 is increased even in the high temperature/high load state, and the performance of the fuel cell can be increased.

To reduce the water content of the electrolyte, the humidity of the oxidation gas is basically controlled so as not to exceed ambient humidity. When the ambient humidity is high, however, the humidity of the oxidation gas may be controlled by circulating the cooling water for dehumidification. Moreover, when the fuel cell is mounted on a vehicle or the like where the operating condition greatly fluctuates, it is desirable to use a humidity controller which performs both humidification and dehumidification from the viewpoint of providing a more excellent I-V characteristic.

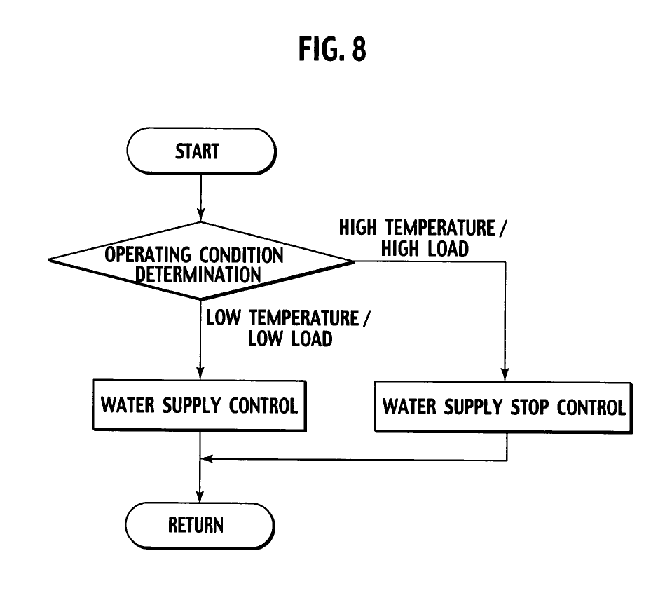

FIG. 8 shows a control flow of the fuel cell control system of the second embodiment. As shown in the figure, the operating condition is determined. In the case of low load, water supply to the oxidation gas is performed by the humidity controller, and in the case of high load, water supply to the oxidation gas is stopped. This increases the protonic conductivity at low temperature/low load (low current density) and allows the fuel cell to operate without flooding to high temperature/high load. Furthermore, since the humidification operation is performed only for low load, the humidity controller such as a humidifier can be miniaturized.

### THIRD EMBODIMENT

In the present invention, the polar substance amount controller is desirably a temperature controller which controls temperature within the fuel cell. In the present invention, furthermore, it is desirable that the temperature controller be a radiator installed outside the fuel cell.

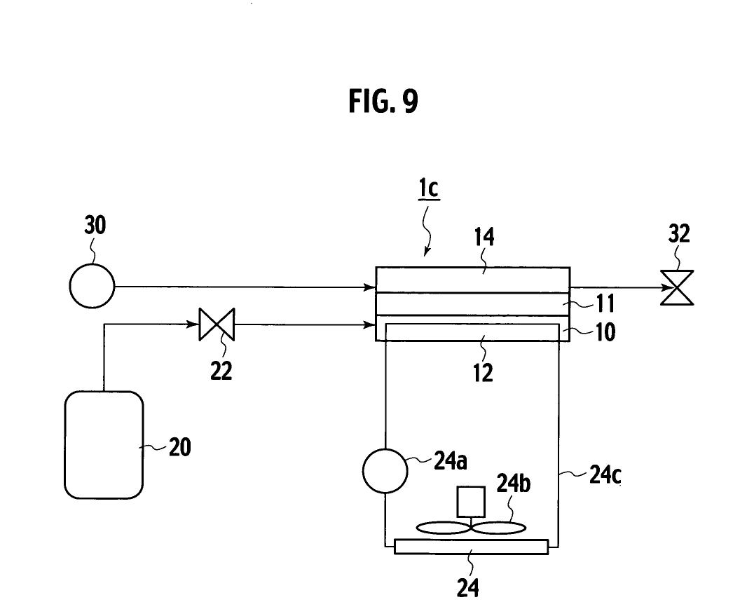

FIG. 9 shows a configuration of a fuel cell control system of a third embodiment of the present invention. As shown in the figure, the fuel cell control system 1c of the present invention includes: a hydrogen tank 20; a fuel cell 10 including an electrolyte 11, an anode 12, and a cathode 14; a radiator 24 as an example of the temperature controller; and a throttle valve 32 as an example of an operating pressure controller.

To the anode 12 side of the fuel cell 10, hydrogen is supplied from the hydrogen tank 20 through a hydrogen regulator 22. Moreover, on the anode 12 side of the fuel cell 10, a passage 24c connected to the radiator 24 is provided. In the passage 24c, a heating medium such as cooling water circulates and is cooled by the radiator 24 and a fan 24b. On the other hand, to the cathode 14 side of the fuel cell 10, oxidation gas (air) is supplied through a compressor 30. FIG. 9 shows that the heating medium circulates on only the anode 12 side. However, specifically, the fuel cell control system is configured so that coolant flows through a coolant passage which is attached to not only the anode 12 but the entire fuel cell 10.

Temperature of the cooling water circulating in the radiator 24 is controlled according to the operating condition of the fuel cell 10. Specifically, in the low temperature/low load (low current density) operating condition, the temperature within the fuel cell 10 lowers. Specifically, the flow rate of the heating medium is increased using a pump 24a or the motor speed of the fan 24b is increased so that an amount of heat removed by the radiator is equal to or more than the amount of heat released from the fuel cell. Water produced during power generation therefore condenses within the fuel cell 10, and the water content of the electrolyte increases. Accordingly, the protonic conductivity of the electrolyte 11 is increased even in the low temperature/low load state, and the performance of the fuel cell can be improved.

On the other hand, in the high temperature/high load (high current density) operating condition, the amount of heat generated by the fuel cell increases, and the room-temperature molten salt which does not contain water has high protonic conductivity. In this operating condition, the radiator is normally operated with the cooling amount being not especially increased. This promotes release of water within the electrolyte and makes it difficult for water produced in power generation to condense within the fuel cell 10. The water content of the electrolyte can be therefore reduced. Accordingly, the protonic conductivity of the electrolyte 11 is increased even in a high temperature/high load state, and the performance of the fuel cell can be increased.

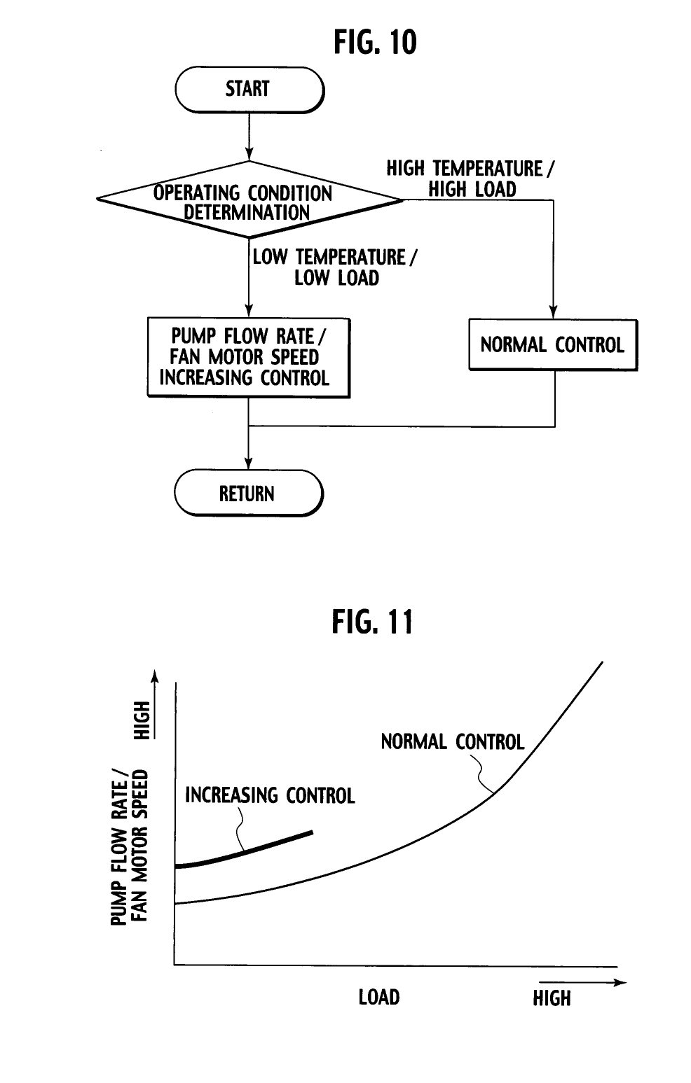

FIG. 10 shows a control flow of the fuel cell control system of the third embodiment. As shown in the figure, first, the operating condition of the fuel cell 10 is determined. In the case of low load, increasing control to increase pump flow rate or fan motor speed of the radiator is carried out by the temperature controller, and in the case of a high load operating condition, a normal control by the temperature controller is carried out.

FIG. 11 shows relations of the pump flow rate and fan motor speed relative to load in the cases of the normal control and the increasing control. When the load on the fuel cell is high, the temperature controller is brought into the normal control, and when the load on the fuel cell is low, the temperature controller is brought into the increasing control. Even when the load on the fuel cell is low, if the electrolyte retains enough water, the temperature controller may be brought into not the increasing control but the normal control.

As described above, by connecting the temperature controller to the fuel cell, the protonic conductivity can be increased at low temperature/low load. Moreover, the fuel cell can operate without flooding up to high temperature/high load. The fuel cell itself can be therefore miniaturized. Furthermore, since the amount of heat removed from the fuel cell is increased mainly in the low load operation, it is not necessary to improve the cooling performance of the temperature controller.

The operating pressure controller, humidity controller, and temperature controller as the aforementioned polar substance amount controller can be used in proper combination.

### (Ionic Conductor)

The cation and anion components used in the ionic conductor of the present invention are described in detail using concrete examples. In the present invention, cation and anion components shown below can be used in proper combinations.

A molecular cation which is a type of the aforementioned cation component is an imidazolium derivative cation and, more specifically, a monosubstituted imidazolium derivative cation expressed by the following formula (1).

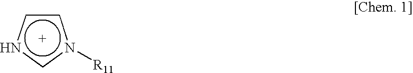

(R₁₁ in the formula indicates hydrogen, a monovalent organic group, preferably, a monovalent hydrocarbon group, or more preferably, an alkyl group or arylalkyl group having 1 to 20 carbon atoms.)

Concrete examples of the carbon hydrogen group can be a methyl group and a butyl group.

Another type of the aforementioned cation component is a disubstituted imidazolium derivative cation expressed by the following formula (2).

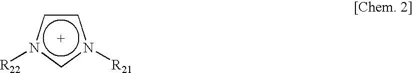

(R₂₁ and R₂₂ in the formula are the same or different, each of which is a monovalent organic group, preferably a monovalent hydrocarbon group, or more preferably an alkyl group or arylalkyl group having 1 to 20 carbon atoms.)

R₂₁ and R₂₂ can be the same as the aforementioned R₁₁. In addition, each of R₂, and R₂₂ can be an ethyl group, a pentyl group, a hexyl group, an octyl group, a decyl group, a dodecyl group, a tetradecyl group, a hexadecyl group, an octadecyl group, a benzyl group, or a γ-phenylpropyl group. Moreover, concrete examples of a typical combination of these substituted groups are: a combination in which R₂₁ is a methyl group and R₂₂ is one of a methyl group, an ethyl group, a butyl group, a pentyl group, a hexyl group, an octyl group, a decyl group, a dodecyl group, a tetradecyl group, a hexadecyl group, an octadecyl group, a benzyl group, and a γ-phenylpropyl group; and a combination in which R₂, is an ethyl group and R₂₂ is a butyl group.

Still another type of the aforementioned cation component can be a trisubstituted imidazolium derivative cation expressed by the following formula (3).

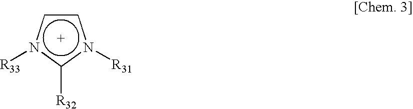

(R₃₁ to R₃₃ in the formula are the same or different, each of which indicates a monovalent organic group, preferably a monovalent hydrocarbon group, or more preferably an alkyl group or arylalkyl group having 1 to 20 carbon atoms. R₃₁ and R₃₃ can be hydrogen.)

R₃₁ to R₃₃ can be the same as the aforementioned R₁₁. In addition, each of R₃₁ to R₃₂ can be an ethyl group, a propyl group, a hexyl group, or a hexadecyl group. Moreover, concrete examples of a typical combination of these substituted groups are: a combination in which R₃₁ is an ethyl group and R₃₂ and R₃₃ are methyl groups; a combination in which R₃₁ is a propyl group and R₃₂ and R₃₃ are methyl groups; a combination in which R₃₁ is a butyl group and R₃₂ and R₃₃ are methyl groups; a combination in which R₃₁ is a hexyl group and R₃₂ and R₃₃ are methyl groups; and a combination in which R₃₁ is a hexadecyl group and R₃₂ and R₃₃ are methyl groups.

Still another type of the aforementioned cation component can be a pyridinium derivative cation expressed by the following formula (4).

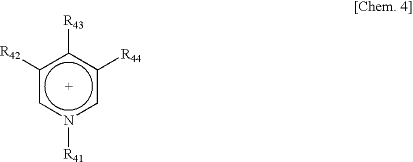

(R₄₁ to R₄₄ in the formula are the same or different, each of which indicates hydrogen, a monovalent organic group, preferably a monovalent hydrocarbon group, or more preferably an alkyl group or arylalkyl group having 1 to 20 carbon atoms.)

R₄₁ to R₄₄ can be the same as the aforementioned R₁₁. In addition, each of R₄₁ to R₄₄ can be hydrogen, an ethyl group, a hexyl group, or an octyl group. Moreover, concrete examples of a typical combination of these substituted groups are: a combination in which R₄₁ is an ethyl group and R₄₂ to R₄₄ are hydrogen; a combination in which R₄₁ is a butyl group and R₄₂ to R₄₄ are hydrogen; a combination in which R₄₁ is a butyl group, R₄₂ to R₄₄ are hydrogen. Other examples thereof are: a combination in which R₄₁ is a butyl group, R₄₂ and R₄₃ are hydrogen, and R₄₄ is a methyl group; a combination in which R₄₁ is a butyl group, R₄₂ and R₄₄ are hydrogen, and R₄₃ is a methyl group; a combination in which R₄₁ is a butyl group, R₄₂ and R₄₃ are methyl groups, and R₄₄ is hydrogen; a combination in which R₄₁ is a butyl group, R₄₂ and R₄₄ are methyl groups, and R₄₃ is hydrogen; and a combination in which R₄₁ is a butyl group, R₄₂ and R₄₃ are hydrogen, and R₄₄ is an ethyl group. Other examples thereof are: a combination in which R₄₁ is a hexyl group and R₄₂ to R₄₄ are hydrogen; a combination in which R₄₁ is a hexyl group, R₄₂ and R₄₃ are hydrogen, and R₄₄ is a methyl group; a combination in which R₄₁ is a hexyl group, R₄₂ and R₄₄ are hydrogen, and R₄₃ is a methyl group; a combination in which R₄₁ is an octyl group and R₄₂ to R₄₄ are hydrogen; a combination in which R₄₁ is an octyl group, R₄₂ and R₄₃ are hydrogen, and R₄₄ is a methyl group; and a combination in which R₄₁ is an octyl group, R₄₂ and R₄₄ are hydrogen, and R₄₃ is a methyl group.

Still another type of the aforementioned cation component can be a pyrrolidinium derivative cation expressed by the following formula (5).

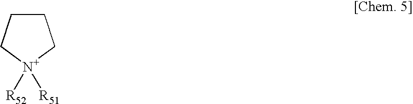

(R₅₁ and R₅₂ in the formula may be the same or different, each of which indicates hydrogen, a monovalent organic group, preferably a monovalent hydrocarbon group, or more preferably an alkyl group or arylalkyl group having 1 to 20 carbon atoms.)

R₅₁ and R₅₂ can be the same as the aforementioned R₁₁. Each of R₅₁ and R₅₂ can be an ethyl group, a propyl group, a hexyl group, or an octyl group. Moreover, concrete examples of a typical combination of these substituted groups are: a combination in which R₅₁ is a methyl group and R₅₂ is any one of a methyl group, an ethyl group, a butyl group, a hexyl group, and an octyl group; a combination in which R₅₁ is an ethyl group and R₅₂ is a butyl group; a combination in which each of R₅₁ and R₅₂ is any one of a propyl group, a butyl group, and a hexyl group.

Still another kind thereof can be an ammonium derivative cation expressed by the following formula (6).

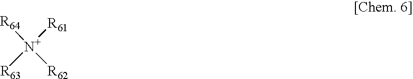

(R₆₁ to R₆₄ in the formula may be the same or different, each of which indicates a monovalent organic group, preferably a monovalent hydrocarbon group, or more preferably an alkyl group or arylalkyl group having 1 to 20 carbon atoms.)

R₆₁ to R₆₄ can be the same as the aforementioned R₁₁. Each of R₆₁ to R₆₄ can be an ethyl group or an octyl group. Moreover, concrete examples of a typical combination of these substituted groups are: a combination in which each of R₆₁ to R₆₄ is any one of a methyl group, an ethyl group, and a butyl group; and a combination in which each of R₆₁ is a methyl group and R₆₂ to R₆₄ are octyl groups.

Still another type of the aforementioned cation component can be a phosphonium derivative cation expressed by the following formula (7).

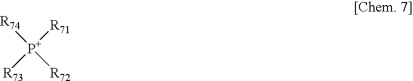

(R₇₁ to R₇₄ in the formula may be the same or different, each of which indicates a monovalent organic group, preferably a monovalent hydrocarbon group, or more preferably an alkyl group or arylalkyl group having 1 to 20 carbon atoms.)

R₇₁ to R₇₄ can be the same as the aforementioned R₁₁. Each of R₇₁ to R₇₄ can be an ethyl group, an isobutyl group, a hexyl group, an octyl group, a tetradecyl group, hexadecyl group, a phenyl group, or a benzyl group. Moreover, concrete examples of a typical combination of these substituted groups are: a combination in which R₇₁ is a methyl group and each of R₇₂ to R₇₄ is a butyl group or an isobutyl group; a combination in which R₇₁ is an ethyl group and each of R₇₂ to R₇₄ is a butyl group; a combination in which each of R₇₁ to R₇₄ is a butyl group or an octyl group; a combination in which R₇₁ is a tetradecyl group and each of R₇₂ to R₇₄ is a butyl group or a hexyl group; a combination in which R₇₁ is a hexadecyl group and R₇₂ to R₇₄ are butyl groups; and a combination in which R₇₁ is a benzyl group and R₇₂ to R₇₄ are phenyl groups.

Still another type of the aforementioned cation component can be a guanidinium derivative cation expressed by the following formula (8).

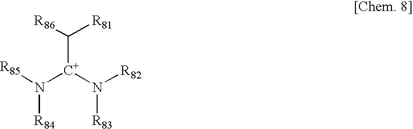

(R₈₁ to R₈₆ in the formula may be the same or different, each of which indicates hydrogen, a monovalent organic group, preferably a monovalent hydrocarbon group, or more preferably an alkyl group or arylalkyl group having 1 to 20 carbon atoms.)

Each of R₈₁ to R₈₆ can be the same as the aforementioned R₁₁ and in addition, can be an ethyl group, a propyl group, or an isopropyl group. Moreover, concrete examples of a typical combination of these substituted groups are: a combination in which all of R₈₁ to R₈₆ are hydrogen or methyl groups; a combination in which R₈₁ is an ethyl group, R₈₂ to R₈₅ are methyl groups, R₈₆ is hydrogen; a combination in which R₈₁ is an isopropyl group, R₈₂ to R₈₅ are methyl groups, R₈₆ is hydrogen; and a combination in which R₈₁ is a propyl group and R₈₂ to R₈₆ are methyl groups.

Still another type of the aforementioned cation component can be an isouronium derivative cation expressed by the following formula (9).

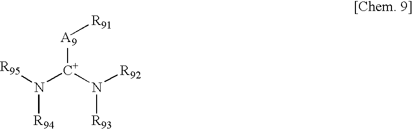

(R₉₁ to R₉₅ in the formula may be the same or different, each of which indicates hydrogen, a monovalent organic group, preferably a monovalent hydrocarbon group, or more preferably an alkyl group or arylalkyl group having 1 to 20 carbon atoms. As indicates an oxygen or sulfur atom.)

Each of R₉₁ to R₉₅ can be the same as the aforementioned R₁₁ and in addition, can be hydrogen or an ethyl group. Moreover, concrete examples of a typical combination of these substituted groups can be: a combination in which A₉ is an oxygen atom and all of R₉₁ to R₉₅ are methyl groups; a combination in which A₉ is an oxygen atom, R₉₁ is an ethyl group, and R₉₂ to R₉₅ are methyl groups; a combination in which A₉ is a sulfur atom (S), R₉₁ is an ethyl group, and R₉₂ to R₉₅ are methyl groups.

On the other hand, the aforementioned molecular anion can be a sulfate anion [SO₄²⁻], a hydrogen sulfate anion [HSO⁴⁻], or a sulfate ester anion expressed by the following formula (10).

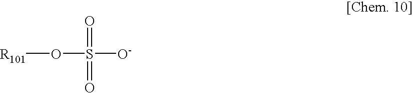

(R₁₀₁ in the formula indicates a monovalent organic group, preferably a monovalent hydrocarbon group, or more preferably an alkyl or arylalkyl group having 1 to 20 carbon atoms.)

R₁₀₁ can be the same as the aforementioned R₁₁. In addition, R₁₀₁ can be an ethyl group, a hexyl group, or an octyl group. Typical concrete examples of the aforementioned molecular anion are anions in which R₁₀₁ is a methyl group, an ethyl group, a butyl group, a hexyl group, or an octyl group.

Moreover, the aforementioned molecular anion can be a sulfate ester anion expressed by the following formula (11).

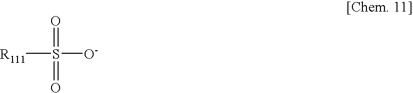

(R₁₁₁ in the formula indicates a monovalent organic group, preferably a monovalent hydrocarbon group, more preferably an alkyl or arylalkyl group having 1 to 20 carbon atoms, or a fluorine-substitution product thereof.)

Typical concrete examples are: an anion in which R₁₁₁ is a fluorine-substituted methyl group (corresponding to a trifluoromethanesulfonate anion); and an anion in which R₁₁₁ is a p-tolyl group (corresponding to a p-toluenesulfonate anion).

Still moreover, the aforementioned molecular anion can be any one of amide and imide anions expressed by the following formulae (12) to (14). The amide and imide anions are not necessarily limited to these anions.

(CN)₂N⁻ [Chem. 12]

[N(CF₃)₂]⁻ [Chem. 13]

[N(SO₂CF₃)₂]⁻ [Chem. 14]

Still moreover, the aforementioned molecular anion can be a methane anion expressed by the following formula (15) or (16). The methane anions are not necessarily limited to these anions.

[HC(SO₂CF₃)₂]⁻ [Chem. 15]

C(SO₂CF₃)₃⁻ [Chem. 16]

Still moreover, the aforementioned molecular anion can be a boron-contained compound anion expressed by any one of the following formulae (17) to (23). The boron-contained compound anion is not necessarily limited to these anions.

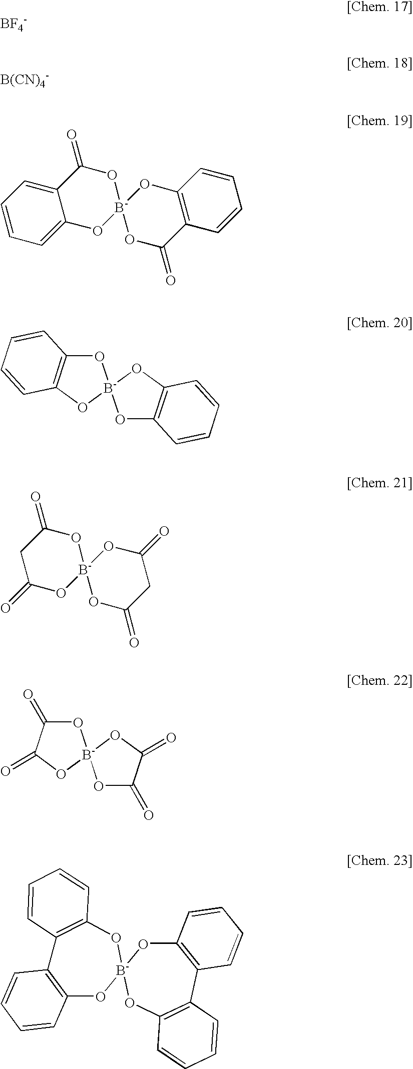

The boron-contained compound anion is not necessarily limited to these anions.

Still moreover, the aforementioned molecular anion can be a phosphorus-contained compound anion expressed by one of the following formulae (24) to (32). The phosphorus-contained compound anion is not necessarily limited to these anions.

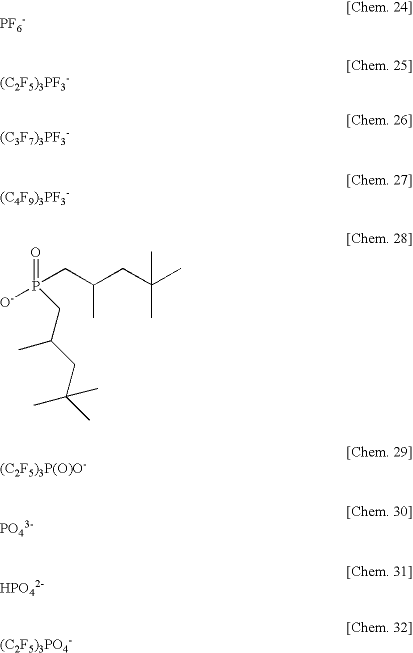

Still moreover, the aforementioned molecular anion can be a carbonate anion expressed by one of the following formulae (33) to (34). The carbonate anion is not necessarily limited to these anions.

C₁₀H₂₁COO⁻ [Chem. 33]

CF₃COO⁻ [Chem. 34]

Still moreover, the aforementioned molecular anion can be a metal element-contained anion expressed by the following formula (35) or (36). The metal element-contained anion is not necessarily limited to these anions.

SbF₆⁻ [Chem. 35]

Co(CO)₄⁻ [Chem. 36]

On the other hand, other examples of the anion component are a fluorine anion (F⁻), a chlorine anion (Cl⁻), a bromine anion (Br⁻), and an iodine anion as halogenide anions, which are not molecular anions.

Furthermore, in the present invention, it is desirable to combine an imidazolium derivative cation, the pyridinium derivative cation, the pyrrolidinium derivative cation, the ammonium derivative cation, or a mixture of an arbitrary combination of these molecular cations with a boron tetrafluoride anion, the trifluoromethanesulfonate anion, a hydrogen fluoride anion [(HFₙ)F⁻ (n is desirably a real number of 1 to 3)], a monohydrogen sulfate anion, a dihydrogenphosphate anion, or an arbitrary combination of these molecular anions. This is because such combinations of the molecular cations and anions are room-temperature molten salt and have good hydrophilic nature.

In the present invention, the used polar substance preferably functions as a polar solvent. It is desirable that the polar substance be an electrically neutral substance in which positive and negative charges are unevenly distributed and be especially a compound having a structure in which positive and negative charges are divided at both ends.

To the indices of such polarity, it is possible to apply a polarity value, dipole moment, permittivity, hydrogen bonding property, and solubility parameter.

The polar substance has preferably a polar value larger than 30, more preferably larger than 40, and still more preferably larger than 50. When the polar substance has a polarity value less than 30, the polarity thereof is insufficient, and it is difficult for the polar substance to fulfill the function as a solvent. Table 1 shows solubility parameters (δ) and polarity values (Et) of typical substances. Table 1 is excerpted from “Shin jikken kagaku kouza (New experimental chemistry)”, Editor: the Chemical Society of Japan, Publisher: Maruzen Co., Ltd.

TABLE 1

| | | Solubility | Polarity |
|---|---|---|---|
| Solvent | Chemical Formula | Parameter (δ) | Value (Et) |
| Water | H₂O | 23.4 | 63.1 |
| Ethanol | C₂H₅OH | 12.9 | 51.9 |
| Methanol | CH₃OH | 14.2 | 55.5 |
| Chloroform | CHCl₃ | 9.24 | 39.1 |
| Tetrahydrofuran | C₄H₈O | — | — |
| Acetone | CH₃COCH₃ | 9.8 | 42.2 |
| Ethyl Acetate | CH₃COOC₂H₅ | 9.04 | 38.1 |
| Butyl Acetate | C₆H₁₂O₂ | — | — |
| Dimethylsulfoxide | (CH₃)₂SO | 13 | 45 |
| Dimethylformamide | (CH₃)₂NOCH | 12 | 43.8 |
| Acetonitrile | CH₃CN | 11.8 | 44.3 |
| Acetic Acid | CH₃COOH | 10.1 | 51.9 |
| 1-propanol | 1-C₃H₇OH | 11.9 | 50.7 |
| 2-propanol | 2-C₃H₇OH | 11.5 | 48.6 |
| 1-butanol | 1-C₄H₉OH | 11.4 | 50.2 |
| Pyridine | C₅H₅N | 10.8 | 40 |
| α-picoline | α-CH₃C₅H₄N | — | 38.3 |
| Dichloromethane | CH₂Cl₂ | 9.88 | 41.1 |
| Carbon | CCl₄ | 8.58 | 32.5 |
| Tetrachloride | | | |
| Benzene | C₆H₆ | 9.15 | 34.5 |
| Cyclohexane | C₆H₁₂ | 8.2 | — |
| Hexane | C₆H₁₄ | 7.24 | 30.9 |

The solubility parameters in the table are calculated from the following Equation 1. A larger solubility parameter indicates a larger solubility.

δ=(E/V)^{1/2} Equation 1

(E and V in the equation indicate cohesive energy of a liquid molecule and a molecular volume, respectively)

Furthermore, in the present invention, the polar substance is suitably water, methanol, ethanol, propanol, butanol, ethylene glycol, propylene glycol, butylene glycol, acetone, acetonitrile, dimethylsulfoxide, dimethylformamide, pyridine, α-picoline, methyl acetate, ethyl acetate, propyl acetate, butyl acetate, acetic acid, ethylene oxide, polyethylene oxide, polypropylene oxide, or a mixture of an arbitrary combination of these polar substances. From the perspective of the high polarity and solubility, water is suitably used.

The polar substance can be a substance of high molecular weight such as polyethylene glycol and polypropylene glycol. Moreover, when such a polar substance of high molecular weight is configured to be contained, it is desirable to add dimethylsulfoxide, dimethylformamide, or the like.

In the ionic conductor of the present invention, the manufacturing method thereof is not particularly limited. The ionic conductor can be produced by a conventionally known method.

In the case of mixing the room-temperature molten salt and water as an example of the polar substance, if the room-temperature molten salt has high viscosity, the room-temperature molten salt and water are heated to about 50 to 80° C. and mixed, thus obtaining a uniform mixture. By mixing the room-temperature molten salt and water, the effect on improving the protonic conductance obtained by the coexistence of the both can be further increased. The molar mixing ratio of the room-temperature molten salt to water in such a case should be 100/1 to 1/5 (room-temperature molten salt/water). Such a ratio can have more effect on improving the protonic conductance.

The method of manufacturing the used room-temperature molten salt is not especially limited, but the room-temperature molten salt can be produced by conventionally known neutralization or the like.

The ionic conductor is described in more detail below using an example and a comparative example, but the present invention is not limited to the example.

### EXAMPLE 1

A room-temperature molten salt (2EtEMImBF₄) composed of 1,2-diethyl-3-methyl-imidazolium cation, which are a type of imidazolium trisubstituted derivative cations, and a boron tetrafluoride anion, which are a type of boron-contained compound anions, and water as an example of the polar substance were mixed in a molar ratio of 1/1 (room-temperature molten salt/water), thus obtaining the ionic conductor of the example.

### COMPARATIVE EXAMPLE 1

An ionic conductor composed of only 2EtEMImBF₄ was used.

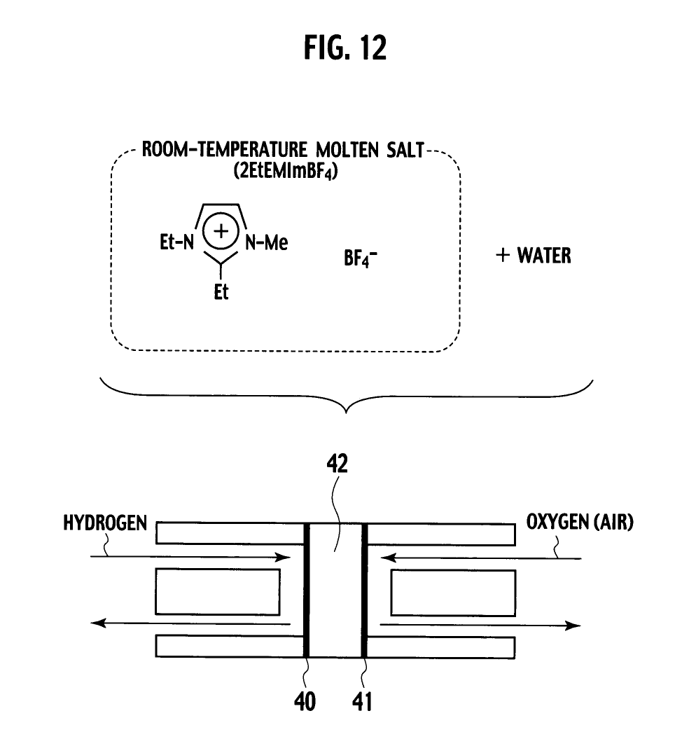

Using the ionic conductors of Example 1 and Comparative Example 1, a generator modeled after the fuel cell was produced. FIG. 12 shows a configuration of the generator. Specifically, an ionic conductor 42 was held between electrodes 40 and 41 which were composed of carbon paper with catalytic metal such as platinum applied thereto.

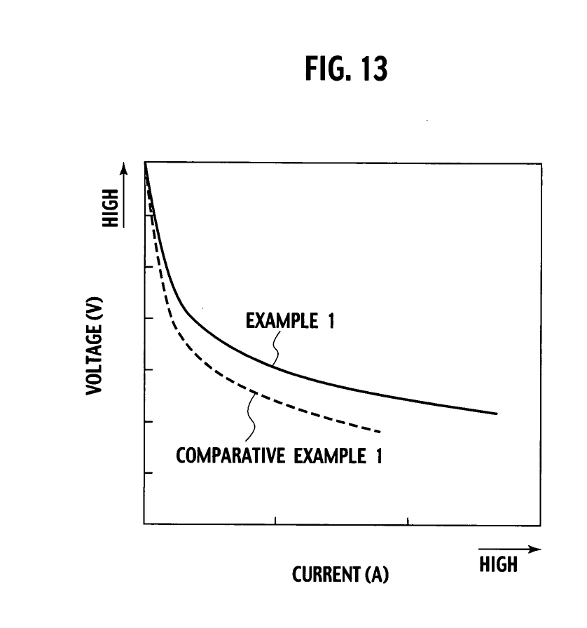

Power generation performances (I-V characteristics) were evaluated with hydrogen and oxygen (air) supplied to the back of the electrode 40 and to the back of the other electrode 41, respectively. FIG. 13 shows the power generation performances (relations between current and voltage) as the obtained results. FIG. 13 revealed that Example 1 was more excellent in the IC characteristic than Comparative Example 1.

The entire contents of Japanese Patent Application P2005-167474 filed on Jun. 6, 2005 and Japanese Patent Application P2005-174855 filed on Jun. 15, 2005 are incorporated by reference herein.

Hereinabove, the details of the present invention are described along the embodiment and example. However, it is obvious for those skilled in the art that the present invention is not limited to these descriptions and can be variously changed and modified.

### INDUSTRIAL APPLICABILITY

The present invention is a fuel cell control system which controls the water content of an electrolyte of a fuel cell using an ionic conductor containing cation and anion components as the electrolyte. The fuel cell control system is characterized by including a polar substance amount controller controlling an amount of polar substance in the electrolyte according to the operating condition of the fuel cell. It is therefore possible to provide a fuel cell control system which can maintain high protonic conductivity in all ranges from the low-load operation range to the high-load operation range.

1. A fuel cell control system, comprising:
a fuel cell using an ionic conductor as an electrolyte, the ionic conductor comprising: a cation component; an anion component; and a polar substance; and
a polar substance amount controller controlling an amount of the polar substance in the electrolyte according to an operating condition of the fuel cell.

2. The fuel cell control system according to claim 1, wherein the polar substance amount controller takes control to increase an amount of the polar substance when the fuel cell is at low temperature, and takes control to reduce the amount of the polar substance when the fuel cell is at high temperature.

3. The fuel cell control system according to claim 1, wherein the polar substance is water.

4. The fuel cell control system according to claim 3, wherein the polar substance amount controller is an operating pressure controller controlling pressure of gas within the fuel cell.

5. The fuel cell control system according to claim 4, wherein the operating pressure controller is a throttle valve attached to a gas exhaust passage connected to an air electrode of the fuel cell.

6. The fuel cell control system according to claim 3, wherein the polar substance amount controller is a humidity controller controlling humidity of at least oxidation gas between gases supplied to the fuel cell.

7. The fuel cell control system according to claim 6, wherein the humidity controller is a humidifier attached to a gas supply passage connected to an air electrode of the fuel cell.

8. The fuel cell control system according to claim 3, wherein the polar substance amount controller is a temperature controller controlling temperature within the fuel cell.

9. The fuel cell control system according to claim 8, wherein the temperature controller is a radiator.

10. The fuel cell control system according to claim 1, wherein at least a part of the cation component is composed of a molecular cation and at least a part of the anion component is composed of a molecular anion.

11. The fuel cell control system according to claim 10, wherein the electrolyte comprises a room-temperature molten salt composed of the molecular cation and the molecular anion.

12. The fuel cell control system according to claim 10, wherein the molecular cation comprises at least one of heteroatoms.

13. The fuel cell control system according to claim 11, wherein the room-temperature molten salt is hydrophilic.

14. The fuel cell control system according to claim 13, wherein at least a part of the room-temperature molten salt is composed of: at least one of the molecular cation selected from a group consisting of an imidazolium derivative cation, a pyridinium derivative cation, a pyrrolidinium derivative cation, and an ammonium derivative cation; and at least one of the molecular anion selected from a group consisting of a boron tetrafluoride anion, a trifluoromethanesulfonate anion, a hydrogen fluoride anion, a monohydrogen sulfate anion, and a dihydrogen phosphate anion.

15. The fuel cell control system according to claim 1, wherein the polar substance has a polarity value more than 30.

16. The fuel cell control system according to claim 1, wherein the polar substance is one selected from the group consisting of water, methanol, ethanol, propanol, butanol, ethylene glycol, propylene glycol, butylene glycol, acetone, acetonitrile, dimethylsulfoxide, dimethylformamide, pyridine, α-picoline, methyl acetate, ethyl acetate, propyl acetate, butyl acetate, acetic acid, ethylene oxide, polyethylene oxide, and polypropylene oxide.

17. The fuel cell control system according to claim 3, wherein a content of water in the electrolyte is 0.01 to 50%.

18. The fuel cell control system according to claim 3, wherein a content of water in the electrolyte is 0.01 to 25%.

19. The fuel cell control system according to claim 3, wherein a content of water in the electrolyte is 0.01 to 10%.

20. A fuel cell control system, comprising:
a fuel cell using an ionic conductor as an electrolyte, the ionic conductor comprising: a cation component; an anion component; and a polar substance; and
polar substance amount control means for controlling an amount of the polar substance in the electrolyte according to an operating condition of the fuel cell.
